(19) United States
(12) Patent Application Publication
(10) Pub. No.: US 2025/0206169 A1
(43) Pub. Date: Jun. 26, 2025

(54) INDUCTIVE CHARGING DEVICE FOR A VEHICLE

(71) Applicant: MAHLE International GmbH, Stuttgart (DE)

(72) Inventor: Mike Boettigheimer, Kornwestheim (DE)

(21) Appl. No.: 18/852,460

(22) PCT Filed: Mar. 24, 2023
(86) PCT No.: PCT/EP2023/057732

§ 371 Date: Sep. 28, 2024

(30) Foreign Application Priority Data
Mar. 30, 2022 (DE) 10 2022 107 570.2
Aug. 16, 2022 (DE) 10 2022 120 691.2

(51) Int. Cl. B60L 53/38; B60L 53/12; H02J 50/00

(52) U.S. Cl. CPC B60L 53/38; B60L 53/12; H02J 50/005

(57) ABSTRACT

An inductive charging device for a vehicle charging system may include an energy transfer winding, at least one positioning signal winding, and at least one flow guide element. The positioning signal winding may be structured as a solenoid with a winding axis extending in at least one of a longitudinal direction of a vehicle and a target vehicle longitudinal direction. The flow guide element may be configured to guide a magnetic field during an energy transfer process between a further inductive charging device and the energy transfer winding. The positioning signal winding may enclose the flow guide element and/or the energy transfer winding.

### CROSS-REFERENCE TO RELATED APPLICATIONS

This application claims priority to International Patent Application No. PCT/EP2023/057732, filed on Mar. 24, 2023, German Patent Application No. DE 10 2022 107570.2, filed on Mar. 30, 2022, and German Patent Application No. DE 10 2022 120 691.2, filed on Aug. 16, 2022, the contents of all of which are hereby incorporated in their entirety.

### TECHNICAL FIELD

The invention relates to an inductive charging device for a vehicle charging system and a vehicle charging system according to the independent claims.

### BACKGROUND

DE 102018210726 A1 describes a positioning antenna that is used to position an inductive secondary unit relative to a primary unit. Here, a coil core of the positioning antenna is simultaneously used as the coil core of a charging coil for inductive energy transmission. The positioning antenna can generate or receive a magnetic measuring field for positioning. The positioning antenna comprises several turns of a conductor and is realized as a cylindrical coil made of ribbon cable. The positioning antenna has an advantageous directional effect.

The positioning antenna must always be positioned between the coil core and the charging coil. Furthermore, no correspondingly advantageous receiver is shown on the opposite side for the simple positioning antenna with advantageous directivity.

### SUMMARY

An inductive charging device for a vehicle charging system with an energy transfer winding and at least one flow guide element and at least one positioning signal winding is proposed, wherein the positioning signal winding is designed as a solenoid with a winding axis in the longitudinal direction of the vehicle or target vehicle longitudinal direction, and the positioning signal winding encloses at least one of the at least one flow guide element and encloses the energy transfer winding.

With inductive charging, energy is transferred in the form of a magnetic field between two inductive charging devices, usually between a stationary charging device and a mobile inductive charging device.

The term “inductive charging device” therefore only refers to one of at least two parts that are required for an inductive energy transfer process. During the inductive energy transfer process, an energy transfer winding in an inductive charging device generates an alternating magnetic field. This alternating magnetic field induces a voltage in another energy transfer winding of another inductive charging device. This additional inductive charging device therefore serves as a counterpart for this specific energy transfer process. The energy is transmitted wirelessly and absorbed by induction of a voltage.

Inductive charging devices can be used for inductive charging of vehicles. In principle, an inductive charging device according to the invention can be used for any type of land, water or air vehicle that has an electric or hybrid drive. In particular, passenger cars, buses and trucks are mentioned here.

A vehicle charging system comprises at least one mobile inductive charging device and another, usually stationary inductive charging device. A mobile inductive charging device can be mounted on and/or in a vehicle, for example.

An inductive charging device on and/or in the vehicle is therefore suitable for picking up the magnetic field and providing electrical energy to an energy storage in the vehicle, for example a battery or an accumulator in the vehicle.

In principle, a vehicle charging system can also be used for bidirectional charging. The vehicle can also temporarily feed energy from the energy storage into the power grid via the vehicle charging system.

An inductive charging device has an energy transfer winding that can efficiently receive a magnetic field from another energy transfer winding and/or emit a magnetic field during the energy transfer process. Preferably, power from 3 kW to 500 KW can be transmitted, particularly preferably from 3 kW to 50 kW.

In general, a coil is defined here as a component for generating or receiving a magnetic field. A coil can consist of a winding and optionally other elements such as a magnetic core and a coil carrier. A winding is a coiled arrangement of a current conductor. A winding can consist of one or more turns, wherein a turn denotes a full turn of a conductor. In general, however, a winding can also consist of less than one turn, for example 0.5 turns. Of course, an incomplete number of windings, such as 2.5 windings, is also possible.

An energy transmission winding can be designed in various forms and consist, for example, of a high-frequency strands with a diameter between 0.5 mm and 10 mm, preferably made of copper.

The energy transfer winding can be designed as a flat coil. A flat coil can be a spiral flat coil, in particular a circular spiral flat coil or a rectangular spiral flat coil. A spiral flat coil can be wound in the form of an Archimedean spiral. The turns can be circular (circular spiral flat coil), but other shapes are also possible, such as square or rectangular or even similar to a rectangle with rounded corners (rectangular spiral flat coil). The spiral lies in one plane. A flat coil is particularly suitable for transmitting the highest possible power between a stationary inductive charging device and a mobile inductive charging device in the vehicle.

Alternatively, the energy transfer winding can be designed similar to a flat coil distributed over several levels, for example three levels, similar to a truncated pyramid.

A flow guide element is suitable for guiding a magnetic field in a predetermined manner. It has a high magnetic permeability with μᵣ>1, preferably μᵣ>50, particularly preferably μᵣ>100. The flow guide element is a magnetic core for the energy transfer winding. In particular, the magnetic field is influenced by the high permeability in such a manner that the greatest possible magnetic flow is transmitted to the energy transfer winding. With a flow guide element, the energy transfer winding picks up a greater magnetic flow than without a flow guide element, all other parameters being equal. A flow guide element can be made of a ferromagnetic or preferably of a ferrimagnetic material, particularly preferably of a ferrite. A flow guide element can preferably be plate-like—in the form of a planar core—and be arranged in the inductive charging device on the side of the energy transfer winding that faces away from the opposite side, i.e. the other inductive charging device.

A positioning signal winding can emit a positioning signal during a positioning process. For example, a positioning signal winding can generate an alternating magnetic field with a certain frequency due to an alternating voltage. In principle, an energy transfer winding can also emit a positioning signal, but it is advantageous to use a separate positioning signal winding to generate a positioning signal, as proposed here. In particular, the positioning signal winding can generate magnetic fields that are more suitable for positioning and, in particular, enable a greater range with the same power. The energy transfer windings are designed in such a manner that they couple as well as possible with the corresponding counterpart. They therefore generally do not have a long range in terms of transmitting or receiving magnetic fields in the longitudinal direction of the vehicle or the target vehicle longitudinal direction. However, this is crucial for a positioning process.

During positioning, the maximum possible power or the maximum possible magnetic fields of the positioning signal are severely limited. They are significantly lower than is the case with an energy transfer process. There is no vehicle on the stationary inductive charging system during the positioning process. It is therefore possible, for example, for a person to stand on the stationary inductive charging device. To ensure that the magnetic fields remain safe for a person, they must not exceed flow densities of 27 μT or 6.25 μT, depending on the frequency range.

With a proposed positioning signal winding, it is possible to generate positioning signals that comply with the limit values or reference values and still enable a long range.

A solenoid is also called a cylindrical coil or solenoid coil. A solenoid can be wound in the form of a helix or a cylindrical spiral. However, the shape of the turns does not have to be circular, but can also have other shapes, such as square or rectangular or even similar to a rectangle with rounded corners. The important difference to the flat coil is that the turns are not in one plane, but extend along an axis. However, two or more turns can also run parallel and thus be in the same plane perpendicular to the axis.

A stationary inductive charging device has a target vehicle longitudinal direction. This is the direction in which the longitudinal direction of the vehicle should be after successful positioning.

If the positioning signal winding is located in a mobile inductive charging device of a vehicle, the winding axis of the positioning signal winding is aligned in the longitudinal direction of the vehicle. If the positioning signal winding is located in a stationary inductive charging device, the winding axis of the positioning signal winding is aligned in the target vehicle longitudinal direction.

In the proposed arrangement, the flow guide element takes over the guidance of a magnetic field for energy transfer during an energy transfer process and the guidance of a magnetic field for positioning during a positioning process. This means that the flow guide element has a dual function, which is particularly advantageous as it allows material and installation space to be used efficiently.

The arrangement of the positioning signal winding around at least one of the at least one flow guide element and around the energy transfer winding is advantageous, as the positioning signal winding can be arranged around an otherwise pre-assembled inductive charging device. In addition, a larger area is covered by the positioning signal winding if it is arranged around at least one of the at least one flow guide element and around the energy transfer winding than, for example, if it is arranged around only one or more flow guide elements. This further reduces the local maximum flow density values with the same power, or in other words, a higher power can be used while maintaining the flow density reference values or flow density limit values, thus achieving a greater range.

It is particularly preferable for the positioning signal winding to be arranged around the entire width of the inductive charging device in order to cover as large an area as possible and thus generate a magnetic field that is as homogeneous as possible.

Preferably, an inductive charging device according to the invention is a mobile inductive charging device which is arranged on and/or in a vehicle or a stationary inductive charging device.

A stationary inductive charging device is the non-mobile part of a vehicle charging system, i.e. the part that does not move with the vehicle.

A stationary inductive charging device can preferably be located on, on or in a floor. This can be an inductive charging device mounted on the surface or an inductive charging device embedded in a surface or floor. A floor can be a roadway, a parking lot surface, a garage floor, a floor in a parking garage or another building. Alternatively, a stationary inductive charging device can also be located on walls or similar.

It is also possible that it is a stationary inductive charging device for a dynamic inductive charging process. In a dynamic inductive charging process, a vehicle's energy storage can be charged while the vehicle is moving. In this case, for example, the stationary inductive charging device can extend along the road under, in or on the road surface.

A mobile inductive charging device can be arranged on and/or in a vehicle. In general, this refers to the part of a vehicle charging system that moves with the vehicle.

Preferably, the positioning signal winding is formed by conductor tracks which are applied to at least one printed circuit board, preferably to at least two printed circuit boards.

Here, the turns of a positioning signal winding are realized in the form of conductor tracks on printed circuit boards.

The conductor tracks can be made of copper, for example.

The conductor tracks can be multi-layered, preferably two-layered.

The cross-section of such a conductor track can be adapted much more flexibly to the conditions imposed by the limited installation space. In particular, it is possible to design the cross-section of the conductor tracks as a rectangle with a low height, wherein the height here is in the dimension perpendicular to the substrate.

The realization of a positioning signal winding by means of conductor tracks on printed circuit boards makes it possible to significantly reduce the height of the positioning signal winding compared to conventional windings based on high-frequency strands, for example. This form of positioning signal winding therefore requires less installation space, particularly in the dimension along the winding axis of the energy transfer winding, which is the most critical in terms of installation space.

Preferably, at least two printed circuit boards are used for a positioning signal winding, wherein one printed circuit board can be arranged on one side of a flow guide element, for example above and another printed circuit board on another side of a flow guide element, for example below. The conductor tracks on the two circuit boards are connected by corresponding flexible or non-flexible connections and thus form a winding. The manufacturing method of a winding based on printed circuit boards is also simpler compared to conventional windings with wound high-frequency stranded conductors.

In an alternative advantageous embodiment, the positioning signal winding is designed as a stranded wire, in particular a high-frequency strands or a wire.

A high-frequency strand consists of several wires that are insulated from one another. This offers advantages, as at high frequencies the current flows mainly near the surface of a conductor and the realization with many individual conductors means that as much conductor surface as possible is available.

The term wire is used here to describe the realization as an insulated single wire, which is then also wound in the form of a plurality of turns.

One advantage of winding the positioning signal as a high-frequency strands or wire is that it is a proven and simple method of manufacture.

For this embodiment, an additional mechanical support structure can be used to prevent the high-frequency strands or wire from slipping on the flow guide element.

Alternatively, it is possible to bond the high-frequency strands or the wire to the at least one flow guide element in order to prevent slippage.

A spacer structure can also be used to ensure a defined distance between the individual turns of the positioning signal winding.

Preferably, the positioning signal winding crosses at least approximately the winding axis of the energy transfer winding.

Depending on the shape of the energy transfer winding, it is not always possible to assign a winding axis directly to it. In this case, the winding axis is assumed to be approximately in the geometric center of the energy transfer winding.

Such an arrangement is advantageous because as little voltage as possible should be induced in the positioning signal winding during an energy transfer process, as the high power that occurs during energy transfer could otherwise destroy or damage the positioning signal winding. The main direction of the magnetic flow in the at least one flow guide element is decisive for this. The main direction of the magnetic field lines at the respective location refers to the direction in which the magnetic field lines mainly extend in the flow guide element. Here the magnetic field lines are mainly tangential. Thus, an arrangement of the positioning signal winding approximately through the center of the energy transfer winding, i.e. crossing the winding axis of the energy transfer winding, is advantageous, since in this case the conductors of the positioning signal winding run at least approximately parallel to the magnetic field lines and therefore only a very low voltage is induced.

In an alternative preferred embodiment, the positioning signal winding is arranged at a distance from the center of the energy transfer winding, in particular close to an edge of the energy transfer winding of the inductive charging device or close to an edge of the inductive charging device.

In this embodiment, the positioning signal winding is shifted to the position at which the positioning signal winding intersects the winding axis of the energy transfer winding. The positioning signal winding is therefore not arranged centrally in relation to the energy transfer winding and also not centrally in the inductive charging device. Compared to the center of the energy transfer winding, the positioning signal winding is located closer to or further away from the inductive charging device, which forms the counterpart. The positioning signal winding is located at a distance from the center of the energy transfer winding in the direction of one edge. “Edge” merely means that the energy transfer winding or the inductive charging device ends there and makes no statement about the shape (e.g. rounded or not) of this edge. In a mobile inductive charging device in particular, this is a front or rear edge, taking into account the longitudinal direction of the vehicle, and in a stationary inductive charging device it is a front or rear edge, taking into account the target vehicle longitudinal direction. For example, the positioning signal winding can be located near an edge or halfway between the edge and the center of the energy transfer winding.

An arrangement at a distance from the center of the energy transfer winding initially has the advantage that a position can be found for the positioning signal winding in which no other components, for example support elements or interruptions in the flow guide elements, make arrangement difficult.

In addition, an arrangement at a distance from the center of the energy transfer winding is also advantageous for a positioning method. If the positioning signal winding is closer to the inductive charging device, which forms the counterpart, compared to the center of the energy transfer winding, the range is increased. If the positioning signal winding is located further away from the inductive charging device, which forms the counterpart, compared to the center of the energy transfer winding, it is still possible to carry out a positioning method up to a smaller minimum rod distance between the two inductive charging devices. It is generally the case that there is not only a maximum range for a positioning method with a vehicle charging system according to the invention, but that even at very small distances between the two inductive charging devices, a usable signal is no longer received from the sensor windings. Therefore, for example, another close positioning method can be used for the area in which the two inductive charging devices are very close to one another. However, this has a very short range. In this respect, it is important that the minimum bar distance up to which a positioning method is possible with an inductive charging device according to the invention is as low as possible. This is achieved by positioning the positioning signal winding further away from the inductive charging device, which forms the counterpart, compared to the center of the energy transfer winding.

Furthermore, a vehicle charging system with a first inductive charging device and a further inductive charging device is proposed herein, wherein the first inductive charging device has at least one energy transfer winding and at least one flow guide element and at least one positioning signal winding and the positioning signal winding is designed as a solenoid with a winding axis in the longitudinal direction of the vehicle or target vehicle longitudinal direction, and the further inductive charging device has at least one energy transfer winding and at least one flow guide element and a first sensor winding with a first radial longitudinal direction and a second sensor winding with a second radial longitudinal direction, and the first radial longitudinal direction and the second radial longitudinal direction are at an angle of between 70° and 110° to one another, preferably perpendicular to one another and at an angle of between 35° and 55° to the longitudinal direction of the vehicle or to the target vehicle longitudinal direction, preferably at an angle of 45° to the longitudinal direction of the vehicle or to the target vehicle longitudinal direction.

Such a design and arrangement of the positioning signal winding and the sensor winding is advantageous both for a positioning process and for an energy transfer process. The design of the positioning signal winding as a solenoid with a winding axis in the longitudinal direction of the vehicle or in the target vehicle longitudinal direction generates a magnetic field with a main direction of the magnetic field lines in the longitudinal direction of the vehicle or in the target vehicle longitudinal direction. On the one hand, this has the advantage that this design enables a significantly greater range for positioning than would be the case with a positioning signal generated by an energy transfer winding with the same power or magnetic field strength. Furthermore, such an orientation of the magnetic field is also particularly suitable for enabling the simplest possible detection of a position deviation or an angular deviation in the sensor windings.

The positioning signal winding is preferably designed in such a manner that it has a particularly large extension in the driving plane and perpendicular to the longitudinal direction of the vehicle or the target vehicle longitudinal direction. For example, the positioning signal winding can extend across the entire width of an inductive charging device. This achieves a largely homogeneous magnetic field with a main direction of magnetic flow in the longitudinal direction of the vehicle or the target vehicle longitudinal direction.

A proposed arrangement of the sensor windings is also advantageous for an optimized positioning process. If the sensor windings are arranged symmetrically to the longitudinal direction of the vehicle or to the target vehicle longitudinal direction, an angular deviation in relation to a homogeneous magnetic field with a clear main direction of magnetic flow can be determined by a simple comparison of the voltages induced in the two sensor windings.

During an energy transfer process, as little voltage as possible should be induced in both the positioning signal winding and the energy transfer winding, as the high power or field strengths during energy transfer could otherwise lead to the destruction of the corresponding windings.

A positioning signal winding according to the invention and sensor signal windings according to the invention can advantageously be arranged in the respective inductive charging device in such a way that the conductors forming these windings run mainly parallel to the main direction of the magnetic flow during energy transmission at the respective location. This ensures that the lowest possible voltage is induced in the respective windings during energy transfer.

In particular, the orientation of the magnetic flow in the respective flow guide elements of the inductive charging devices is decisive for this. This can preferably run radially outwards from the center of the respective energy transfer winding.

Preferably, the first inductive charging device is a mobile inductive charging device which is arranged on and/or in a vehicle and the further inductive charging device is a stationary inductive charging device or the first inductive charging device is a stationary inductive charging device and the further inductive charging device is a mobile inductive charging device which is arranged on and/or in a vehicle.

Advantageously, the positioning signal winding encloses at least one of the at least one flow guide elements.

In the proposed arrangement, the flow guide element takes over the guidance of a magnetic field for energy transfer during an energy transfer process and the guidance of a magnetic field for positioning during a positioning process. The flow guide element therefore has a dual function here.

Preferably, the positioning signal winding crosses at least approximately the winding axis of the energy transfer winding of the first inductive charging device and the first radial longitudinal direction and the second radial longitudinal direction cross at least approximately in the center of the energy transfer winding of the further inductive charging device.

This arrangement means that the conductors that form the positioning signal winding and the sensor windings run at least approximately parallel to the magnetic field lines that are generated at the respective location during energy transmission. This ensures that the lowest possible voltage is induced in the corresponding windings during energy transfer and that they are therefore not destroyed by the high power that occurs during energy transfer.

The center of the energy transfer winding here refers to the area a few centimeters around the geometric center of the energy transfer winding in the plane perpendicular to the winding axis of the energy transfer winding.

A corresponding arrangement of the sensor windings is advantageous, as the two radial longitudinal directions of the two sensor windings are tilted at an angle to the longitudinal direction of the vehicle, which is advantageous for optimum detection of a positional deviation between the vehicle and the stationary inductive charging device.

In addition, the sensor windings are arranged in relation to the energy transfer winding in such a manner that the lowest possible voltages are induced in the sensor windings during the energy transfer process.

In one embodiment, the two sensor windings cross at least approximately in the center of the energy transfer winding. The fact that only the radial longitudinal directions of the two sensor windings cross approximately in the center of the energy transfer winding is a weaker condition. It is also possible for the two sensor windings to be relatively short and arranged in a “V” shape. If these two sensor windings are mentally extended in their radial longitudinal direction, these radial longitudinal directions cross, but not the two sensor windings themselves. The fact that the two sensor windings cross themselves is a tighter condition. Compared to a “V”-shaped arrangement, the sensor windings are longer and actually cross one another. The arrangement is “X”-shaped. In this embodiment, the sensor windings have a larger area into which voltage is induced than in embodiments in which only the radial longitudinal directions of the sensor windings cross in the extension and more voltage can be induced. In this case, an actual crossing of the sensor windings takes place and no longer just a crossing in the extension of the sensor windings.

In this embodiment, it is advantageous if the two sensor windings are arranged point-symmetrically to the center of the energy transfer winding.

In an alternative preferred embodiment, the inductive charging device has at least four sensor windings, wherein two are arranged on opposite sides of the center of the energy transmission winding and all radial longitudinal directions run approximately through the center of the energy transmission winding and/or the four radial longitudinal directions of the four sensor windings each form an angle of 45°+/−10°, preferably 45°, with the longitudinal direction of the vehicle.

Thus, the four sensor windings are arranged in a cross around the center of the energy transfer winding, wherein the center of the energy transfer winding itself is free of a sensor winding.

Preferably, the four sensor windings can be arranged radially at equal distances around the center of the energy transfer winding and at approximately the same angle to one another. For example, the angle between the respective radial longitudinal direction of a sensor winding and the radial longitudinal direction of the respective neighboring sensor winding can always be 45°+/−10°, preferably 45°.

On the one hand, this embodiment is advantageous compared to the embodiment with only two sensor windings, as the installation space can be used more efficiently in this arrangement and thus more turns per sensor winding can be realized. More voltage is therefore induced overall. Compared to the embodiment with two intersecting sensor windings, it also offers the advantage that the center of the energy transfer winding remains free of a sensor winding and thus stabilizing elements can be introduced in this area.

The four sensor windings can be interconnected, preferably in series. It is particularly preferable to connect the two diagonally opposite sensor windings in series with one another.

In an advantageous variant, the positioning signal winding is arranged at a distance from the center of the energy transfer winding of the first inductive charging device, in particular close to an edge of the energy transfer winding of the first inductive charging device or close to an edge of the first inductive charging device.

Particularly preferably, the positioning singal winding is arranged further away from the further inductive charging device during a positioning process than the center of the energy transfer winding of the first inductive charging device.

It is generally the case that there is not only a maximum range for a positioning method with a vehicle charging system according to the invention, but also that no usable signal is received from the sensor windings even at very small distances, in particular at very small distances in the driving plane, between the two inductive charging devices. Therefore, for example, another close positioning method can be used for the area in which the two inductive charging devices are very close to one another. However, this has a very short range. In this respect, it is important that the minimum bar distance up to which a positioning method is possible with an inductive charging device according to the invention is as low as possible. This is achieved by arranging the positioning signal winding further away from the center of the energy transfer winding of the first inductive charging device than the other inductive charging device.

Particularly preferably, the positioning signal winding is formed by conductor tracks which are applied to at least one printed circuit board, and
the first sensor winding and the second sensor winding are formed by conductor tracks which are applied to at least one printed circuit board.

The realization of a sensor winding by means of conductor tracks on printed circuit boards makes it possible to significantly reduce the height of the sensor winding compared to conventional windings based on high-frequency strands, for example. This form of sensor winding therefore requires less installation space, particularly in the dimension along the winding axis of the energy transfer winding, which is the most critical in terms of installation space. The respective printed circuit board can be of any shape and/or dimensions. Preferably, the respective printed circuit board has a shape extending in the direction of the turns with a width, which is formed transversely to the longitudinal direction of the turns, of between 20 mm and 60 mm, in particular from 30 mm to 50 mm, preferably of 40 mm. So that there can be several windings on it, especially next to one another. Preferably, the respective printed circuit board has several turns between 7 and 20, in particular from 10 to 16, preferably 13. The manufacturing method for sensor windings based on printed circuit boards is also simpler compared to conventional sensor windings with wound high-frequency stranded conductors.

In a preferred embodiment, the first sensor winding and/or the second sensor winding and/or the positioning signal winding comprise upper conductor tracks on an upper circuit board and lower conductor tracks on a lower circuit board.

The conductor tracks on the upper circuit board can be connected to the conductor tracks on the lower circuit board to create a spiral winding.

The upper conductor track can be arranged predominantly above one or more flow guide elements and the lower conductor track can be arranged predominantly below one or more flow guide elements.

The terms “above” and “below” or “upper” and “lower” refer to the arrangement of an inductive charging device that extends mainly parallel to the ground. Should a loading device be arranged parallel to a wall, for example, the terms are still to be understood in the sense of “on one side of the flow guide elements” and “on the other side of the flow guide elements”, without departing from the scope of the invention.

Preferably, the upper conductor tracks are connected to the lower conductor tracks via plated-through and/or surface-soldered connector strips and socket strips.

By using connector strips and socket strips, it is possible to establish a connection without soldering the conductor tracks during the assembly of the inductive charging device. This offers considerable advantages in production.

This is particularly the case with the version with plated-through plug and socket connectors.

However, the use of plug connectors and socket connectors can also be accompanied by a soldering process if surface-mounted or surface-soldered (SMD) plug connectors and socket connectors are used, although this is much simpler than a soldering process without corresponding plug devices.

In an alternative preferred variant, the upper conductor tracks are connected to the lower conductor tracks via flexible printed circuit boards.

The upper circuit boards and the lower circuit boards can still be designed as rigid circuit boards. The flexible printed circuit boards provide the connection via the vertical end faces and thus complete the winding for the coil around the at least one flow guide element. The result is a combination of rigid and flexible printed circuit boards. This combination is also known as rigid-flex printed circuit boards. This is also a variant that enables simpler and more suitable production than soldering on site.

The electrical current flowing through the respective positioning signal winding, preferably the effective value, is in particular between 130 mA and 390 mA, for example between 195 mA and 325 mA, preferably 260 mA.

The invention further includes an inductive charging device for a vehicle charging system according to the invention, wherein the inductive charging device has an energy transfer winding and at least one flow guide element and at least one positioning signal winding, wherein the positioning signal winding is designed as a solenoid with a winding axis in the longitudinal direction of the vehicle or target vehicle longitudinal direction and the flow guide element is suitable for conducting a magnetic field during an energy transfer process to or from the inductive charging device and the positioning signal winding encloses at least one of the at least one flow guide elements.

In a further preferred embodiment example, several flow guide elements are arranged radially around the center of the energy transfer winding, wherein gaps between the flow guide elements also extend radially.

In terms of manufacturing technology, it is impossible or very difficult to produce a large flow guide element that covers the entire surface of the energy transfer coil or even extends beyond it. Therefore, several smaller flow guide elements usually have to be placed next to one another. It is possible to use rectangular flow guide elements. These are easier to produce. There are always smaller gaps between the flow guide elements. These can have a negative effect on the guidance of the magnetic field. With rectangular flow guide elements, the gaps between the flow guide elements will always be partially perpendicular to the magnetic field lines. It is therefore advantageous if the gaps between the flow guide elements are also radial and thus influence the guidance of the magnetic field as little as possible.

Alternatively, several flow guide elements can be designed as at least approximately rectangular tiles with gaps between the flow guide elements.

Further important features and advantages of the invention are apparent from the subclaims, from the drawings and from the associated description of the figures with reference to the drawings.

It is understood that the features mentioned above and those to be explained below can be used not only in the combination specified in each case, but also in other combinations or on their own, without departing from the scope of the present invention.

Preferred embodiments of the invention are illustrated in the drawings and are explained in more detail in the following description, wherein identical reference numerals refer to identical or similar or functionally identical components.

### BRIEF DESCRIPTION OF THE DRAWINGS

In the drawings, schematically in each case:

FIG. 1 shows a highly simplified representation of a vehicle with an inductive charging device above a stationary inductive charging device

FIG. 2 shows a schematic top view of an inductive charging device according to the invention

FIG. 3 shows a schematic top view of an alternative inductive charging device according to the invention

FIG. 4 shows a schematic side view of two alternative inductive charging devices according to the invention

FIG. 5 shows a schematic perspective view of a positioning signal winding according to the invention

FIG. 6 shows a schematic representation of the directions in a winding

FIG. 7 shows a schematic representation of a vehicle loading system according to the invention during the positioning process

FIG. 8 shows a top view of an inductive charging device with sensor windings according to the invention

FIG. 9 shows a top view of an alternative inductive charging device according to the invention with positioning signal windings

### DETAILED DESCRIPTION

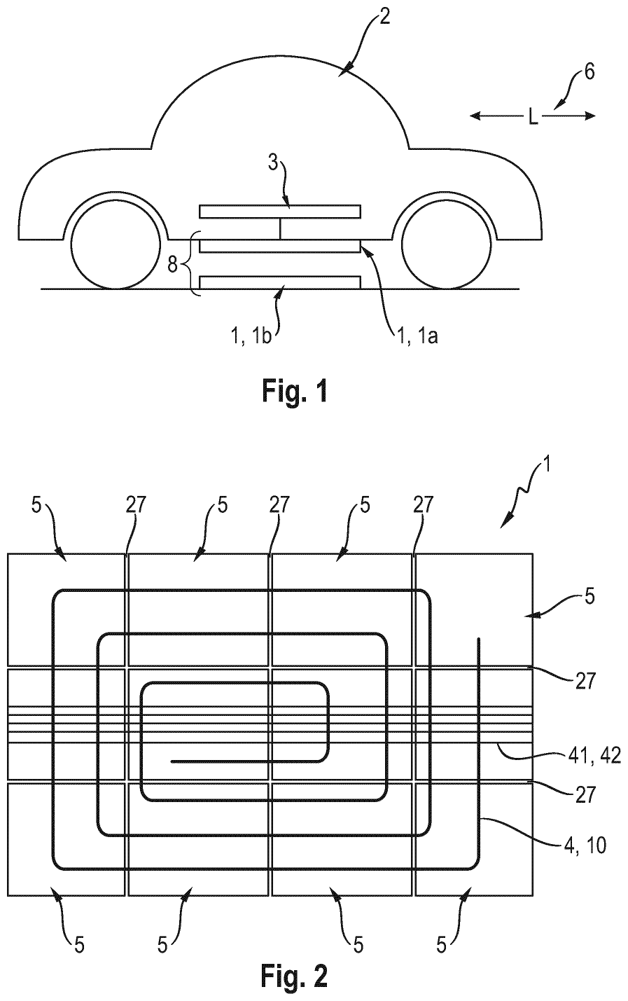

FIG. 1 shows a mobile inductive charging device 1a, which is arranged on a vehicle 2 with an energy storage 3 and is positioned above a stationary inductive charging device 1b. During operation, energy can be transferred from the stationary inductive charging device 1b to the mobile inductive charging device 1a and the energy storage of the vehicle 3 can be charged as a result.

The mobile inductive charging device la and the stationary inductive charging device 1b together form or are part of a vehicle charging system 8. In principle, it is also possible to operate the vehicle charging system 8 bidirectionally. Energy can be temporarily transferred from the mobile inductive charging device 1a to the stationary inductive charging device 1b. The stationary inductive charging device 1b arranged on the ground in FIG. 1 can alternatively be recessed into the road surface (not shown here). In a recessed arrangement, the inductive charging device 1b can be covered by certain layers of the road surface or be flush with the road surface.

FIG. 2 shows an inductive charging device 1 according to the invention with an energy transfer winding 4 and several flow guide elements 5. The energy transfer winding 4 is designed as a flat coil 10. A positioning signal winding 41 is arranged around the flow guide elements 5 and around the energy transfer winding 4. The positioning signal winding 41 is designed as a solenoid 42. The positioning signal winding 41 is arranged centrally and across the middle of the energy transfer winding 4.

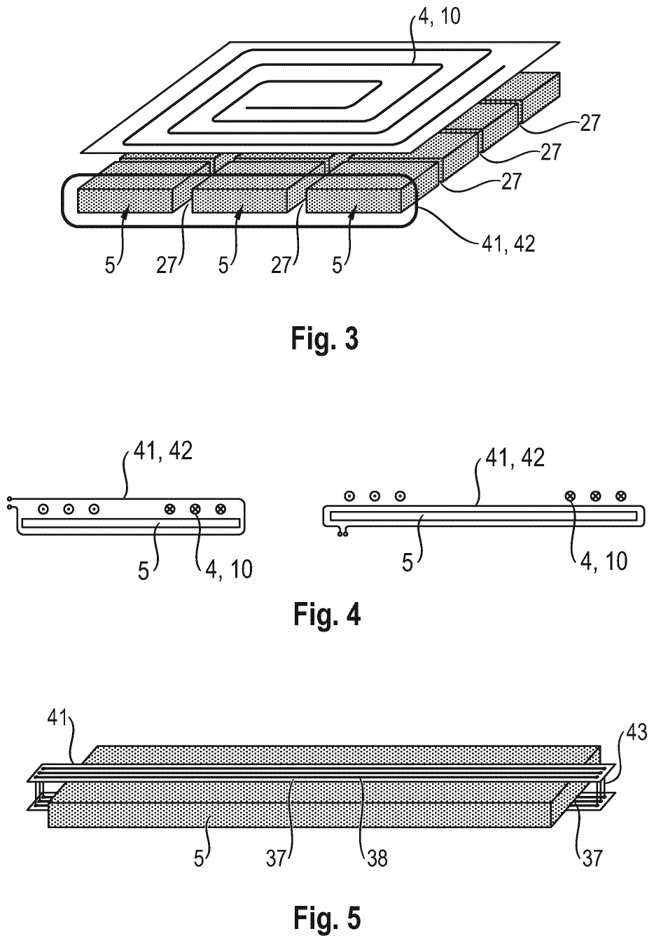

FIG. 3 shows an alternative inductive charging device 1 according to the invention. In contrast to the embodiment in FIG. 2, the positioning signal winding 41 is arranged here only around the flow guide elements 5 but not around the energy transfer winding 4. Furthermore, the positioning signal winding 41 here does not run across the center of the energy transfer winding 4, but is arranged near an edge of the inductive charging device 1.

FIG. 4 shows a side view of two different inductive charging devices 1 according to the invention. On the left, the embodiment is shown in which a positioning signal winding 41 encloses the energy transfer winding 4 and the flow guide elements 5. The positioning signal winding 41 is therefore also wound around the energy transfer winding 4, as in FIG. 2. On the right is shown the embodiment in which a positioning signal winding 41 encloses the flow guide elements 5 but not the energy transfer winding 4. As in FIG. 3, the positioning signal winding 41 is therefore not wound around the energy transfer winding 4.

FIG. 5 shows a schematic perspective view of a positioning signal winding 41 according to the invention. This is arranged here around a flow guide element 5. The positioning signal winding 41 is realized as conductor tracks 38 on printed circuit boards 37. The conductor tracks are connected at the short vertical edges using flexible elements as connecting elements 43.

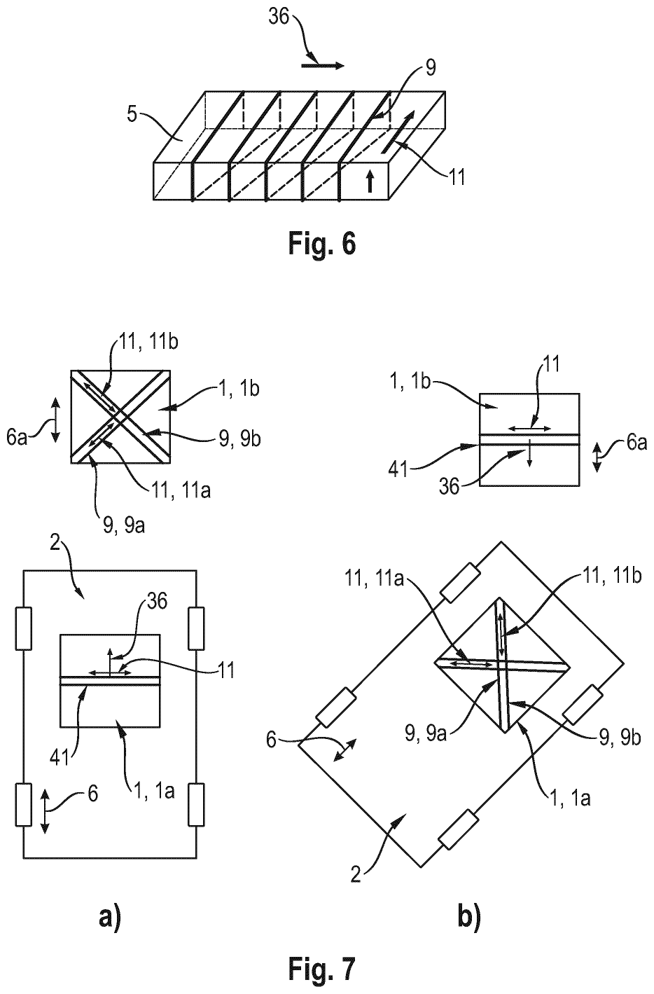

FIG. 6 shows schematically how the directions, in particular the radial longitudinal direction 11 in a winding, in particular in a sensor winding, are defined here. The example in FIG. 6 is a cylindrical coil with five turns. The direction along which the winding was wound is the winding axis 27. The coil here has a rectangular, not square, cross-section. The direction along the longer side of the rectangle is referred to here as the longitudinal radial direction 11. If the cross-section is not rectangular but elliptical, the radial longitudinal direction 11 runs along the main axis of the ellipse.

FIG. 7a) schematically shows a vehicle 2 with a vehicle longitudinal direction 6 with a mobile inductive charging device 1a during a positioning process over a stationary inductive charging device 1b with a target vehicle longitudinal direction 6a. In the present case, the vehicle 2 drives towards the stationary inductive charging device 1b and the target vehicle longitudinal direction 6a is therefore the same as the longitudinal direction of the vehicle 6. The vehicle charging system includes the mobile inductive charging device 1a and the stationary inductive charging device 1b. In addition to the energy transfer winding (not shown), the mobile inductive charging device 1a also contains a positioning signal winding 41. The positioning signal winding 41 has a winding axis 27 and a radial longitudinal direction 11. The conductors forming the positioning signal winding 41 extend mainly along the radial longitudinal direction 11. The positioning signal winding 41 thus generates a magnetic field during operation, wherein the orientation of the magnetic field lines are to a large extent parallel to the winding axis 27 in one plane.

A magnetic field aligned in this manner is particularly suitable for detecting a position deviation or an angular deviation with respect to the stationary inductive charging device 1b. In addition to the energy transfer winding (not shown), the stationary inductive charging device 1b has two sensor windings 9a and 9b. Both sensor windings each have a radial longitudinal direction 11a and 11b, in which the conductors that form the sensor windings mainly extend. Both sensor windings are arranged at an angle of 45° to the target vehicle longitudinal direction 6a and thus to the longitudinal direction of the vehicle 6 in the target position and symmetrically to the target vehicle longitudinal direction 6a. The two sensor windings 9a and 9b or their radial longitudinal directions 11a and 11b are therefore perpendicular to one another. This arrangement of the windings for positioning is particularly advantageous. The positioning signal winding 41 generates a fairly homogeneous magnetic field with magnetic field lines that mainly extend in the driving plane and parallel to the longitudinal direction of the vehicle. A voltage is induced in the sensor windings 9a and 9b by the magnetic field of the positioning signal winding 41. This voltage is proportional to the component of the magnetic field which is perpendicular to the respective radial longitudinal direction 11a, 11b of the sensor winding. If the vehicle drives exactly perpendicular to the stationary inductive charging device 1b, as shown in the left-hand sketch, an equal voltage is induced in both sensor windings 9a and 9b.

FIG. 7b) shows an embodiment example in which the positioning signal winding 41 is arranged in the stationary inductive charging device 1b and the sensor windings 9a and 9b are arranged in the mobile inductive charging device 1a. The functionality of this design example is otherwise exactly the same. Shown here is a case in which the vehicle 2 does not drive perpendicularly towards the stationary inductive charging device 1b, but deviates from it at an angle of approx. 45°. Vehicle longitudinal direction 6 and target vehicle longitudinal direction 6a are therefore at an angle of 45° to one another. In this case, the positioning signal winding 41 generates a magnetic field which is perpendicular to the first sensor winding 9a. A maximum voltage is induced here. The magnetic field generated by the positioning signal winding 41 is also approximately parallel to the second sensor winding 9b. A minimum or no voltage is induced here.

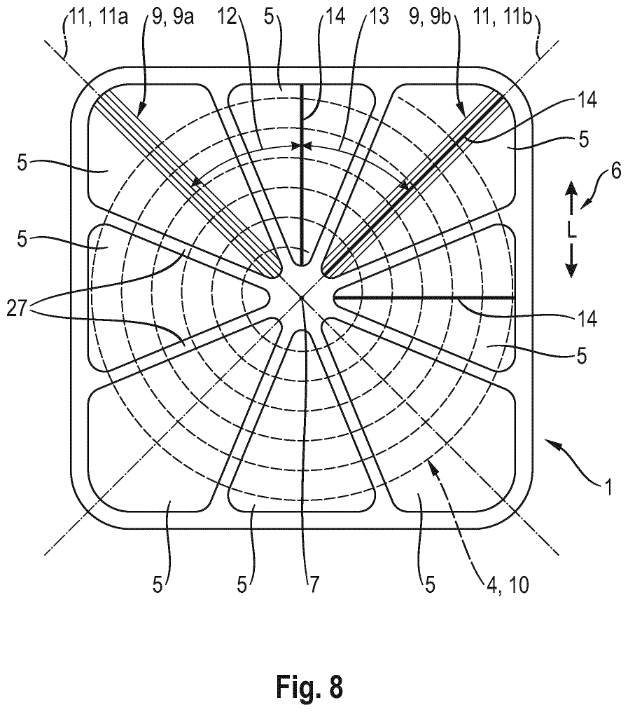

FIG. 8 shows a top view of an inductive charging device 1 according to the invention. This can be a mobile inductive charging device 1a or a stationary inductive charging device 1b. In the present embodiment example, eight flow guide elements 5 are shown, which are arranged radially around the center 7 of the energy transfer winding 4 in the plane. There are narrow gaps 27 between the flow guide elements 5. The gaps also run radially around the center 7, so the gaps run approximately in the main direction of the magnetic field lines (three magnetic field lines 14 symbolically indicated here), which occurs when energy is transferred in the flow guide elements 5. The energy transfer winding 4, which is covered by the flow guide elements 5 in the plan view, is indicated by a dashed line. The energy transmission winding 4 here is a flat coil 10. A first sensor winding 9, 9a is arranged around one of the flow guide elements 5 and a second sensor winding 9, 9b is arranged around another flow guide element 5. The sensor windings are designed here as a solenoid, also known as a cylindrical coil. The first sensor winding 9a is arranged axially symmetrically to the second sensor winding 9b with respect to the longitudinal direction of the vehicle 6 (or the target vehicle longitudinal direction 6a). The first sensor winding 9a has a first radial longitudinal direction 11a and the second sensor winding 9b has a second radial longitudinal direction 11b. The angle 12 between the first radial longitudinal direction 11a and the longitudinal direction 6 of the vehicle 2 is at least approximately the same as the angle 13 between the second radial longitudinal direction 11b and the longitudinal direction of the vehicle. The first radial longitudinal direction 11a and the second radial longitudinal direction 11b intersect or cross each other at least approximately in the center 7 of the energy transfer winding 4. The first radial longitudinal direction 11a and the second radial longitudinal direction 11b run radially outwards from the center 7 of the energy transfer winding 4.

During the charging process, the vehicle 2 is positioned above the stationary inductive charging device 1b and energy is transferred to the inductive charging device 1a. The flow guide elements 5 take over the function of the flow guide. In them, the field lines of the magnetic field run approximately in a radial direction when charged. Three magnetic field lines 14 are symbolically indicated in FIG. 3. Since the first radial longitudinal direction 11a and the second radial longitudinal direction 11b are also aligned radially here and thus at least approximately parallel to the magnetic field lines 14, only relatively little to no voltage is induced in the first sensor winding 9a and in the second sensor winding 9b. This is important, as the high power of the energy transmission and thus high flow densities could otherwise easily destroy the sensor windings. Additional effort to prevent the destruction of the arrangement is therefore not necessary.

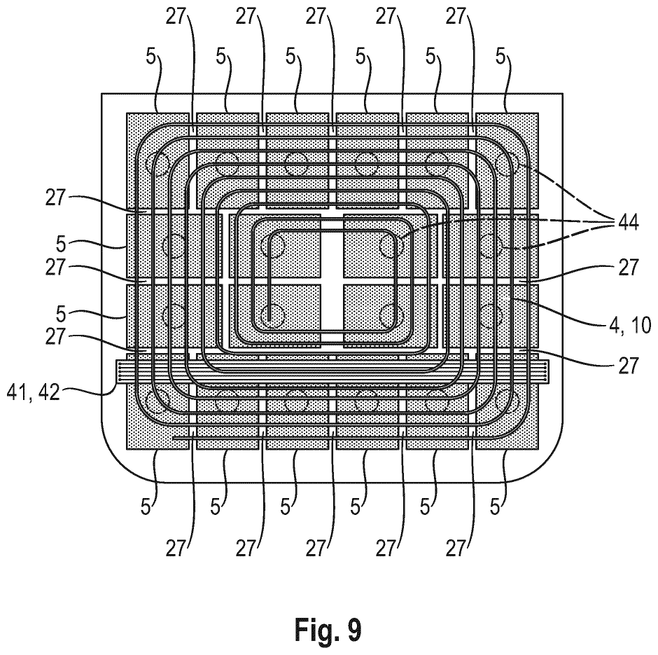

FIG. 9 shows an alternative preferred embodiment of an inductive charging device 1 with a positioning signal winding 41. The inductive charging device 1 has an energy transfer winding 4 and a positioning signal winding 41. The positioning signal winding 41 is designed as a solenoid 42. The inductive charging device 1 also has several flow guide elements 5. These are spaced apart from one another by gaps 27. The positioning signal winding 41 is arranged around the flow guide elements 5, but is not arranged around the energy transfer winding 4. The energy transfer winding 4 is designed as a flat coil 10. The flow guide elements 5 are arranged on mechanical support elements 44. The positioning signal winding 41 is arranged in such a manner that no support elements 44 extend in this area and only gaps 27 extend between the flow guide elements 5 in one direction.

1. An inductive charging device for a vehicle charging system, comprising:
an energy transfer winding;
at least one positioning signal winding structured as a solenoid with a winding axis extending in at least one of a longitudinal direction of a vehicle and a target vehicle longitudinal direction; and
at least one flow guide element configured to guide a magnetic field during an energy transfer process between a further inductive charging device and the energy transfer winding;
wherein the at least one positioning signal winding encloses the at least one flow guide element and encloses the energy transfer winding.

2. The inductive charging device according to claim 1, wherein the inductive charging device is a mobile inductive charging device arranged at least one of on and in the vehicle.

3. The inductive charging device according to claim 1, wherein the at least one positioning signal winding is defined by a plurality of conductor tracks applied to at least one printed circuit board.

4. The inductive charging device according to claim 1, wherein the at least one positioning signal winding is structured as a strand.

5. The inductive charging device according to claim 1, wherein the at least one positioning signal winding at least approximately crosses a winding axis of the energy transfer winding.

6. The inductive charging device according to claim 1, wherein the at least one positioning signal winding is arranged spaced apart from a center of the energy transfer winding.

7. A vehicle charging system, comprising a first inductive charging device and a second inductive charging device, wherein:
the first inductive charging device includes:
at least one energy transfer winding; and
at least one flow guide element; and
at least one positioning signal winding (41) structured as a solenoid with a winding axis extending in at least one of a longitudinal direction of a vehicle and a target vehicle longitudinal direction;
the second inductive charging device includes:
at least one energy transfer winding;
at least one flow guide element;
a first sensor winding with a first radial longitudinal direction; and
a second sensor winding with a second radial longitudinal direction; and
the first radial longitudinal direction and the second radial longitudinal direction are arranged at a first angle of 70° to 110° to each other and at a second angle of 35° to 55° to at least one of the longitudinal direction of the vehicle and the target vehicle longitudinal direction.

8. The vehicle charging system according to claim 7, wherein:
the first inductive charging device is one of i) a mobile inductive charging device arranged at least one of on and in the vehicle and ii) a stationary inductive charging device; and
the second inductive charging device is the other one of i) the mobile inductive charging device and ii) the stationary inductive charging device.

9. The vehicle charging system according to claim 7, wherein the at least one positioning signal winding encloses the at least one flow guide element of the first inductive charging device.

10. The vehicle charging system according to claim 7, wherein:
the at least one positioning signal winding crosses at least approximately a winding axis of the at least one energy transfer winding of the first inductive charging device; and
the first radial longitudinal direction and the second radial longitudinal direction intersect at least approximately in a center of the at least one energy transfer winding of the second inductive charging device.

11. The vehicle charging system according to claim 7, wherein the at least one positioning signal winding is arranged spaced apart from a center of the at least one energy transfer winding of the first inductive charging device.

12. The vehicle charging system according to claim 11, wherein the at least one positioning signal winding is arranged further away from the second inductive charging device than the center of the at least one energy transfer winding of the first inductive charging device during a positioning process.

13. The vehicle charging system according to claim 7, wherein:
the at least one positioning signal winding is defined via a plurality of first conductor tracks applied to at least one first printed circuit board; and
the first sensor winding and the second sensor winding are defined by a plurality of second conductor tracks applied to at least one second printed circuit board.

14. An inductive charging device for the vehicle charging system according to claim 7, comprising:
an energy transfer winding (4) and at least one flow guide element (5) and at least one positioning signal winding (41), wherein
at least one positioning signal winding structured as a solenoid with a winding axis extending in at least one of a longitudinal direction of a vehicle and a target vehicle longitudinal direction; and
at least one flow guide element configured to guide a magnetic field during an energy transfer process at least one of to and from the inductive charging device;
wherein the at least one positioning signal winding encloses the at least one flow guide element.

15. The vehicle charging system according to claim 7, wherein:
the first angle is 90°; and
the second angle is 45°.

16. The vehicle charging system according to claim 11, wherein the at least one positioning signal winding is arranged adjacent to an edge of the first inductive charging device.

17. The vehicle charging system according to claim 13, wherein:
the at least one first printed circuit board includes a plurality of first printed circuit boards;
the at least one second printed circuit board includes a plurality of second printed circuit boards; and
the plurality of second printed circuit boards are separate and distinct from the plurality of first printed circuit boards.

18. The inductive charging device according to claim 1, wherein the inductive charging device is a stationary inductive charging device.

19. The inductive charging device according to claim 1, wherein the at least one positioning signal winding is defined by a plurality of conductor tracks applied to at least two printed circuit boards.

20. The inductive charging device according to claim 6, wherein the at least one positioning signal winding is arranged adjacent to an edge of the energy transfer winding.
